(19) United States
(12) Patent Application Publication
(10) Pub. No.: US 2026/0179127 A1
(43) Pub. Date: Jun. 25, 2026

(54) Systems, Methods, and Devices for Customer Review Moderation

(71) Applicant: WSC 8031 OpCo 1 LLC d/b/a Fera Commerce Inc., Sheridan, WY (US)

(72) Inventor: Najib El Kaake, Sheridan, WY (US)

(21) Appl. No.: 18/841,785

(22) PCT Filed: Mar. 28, 2024
(86) PCT No.: PCT/CA2024/050403

§ 371 Date: Aug. 27, 2024

(30) Foreign Application Priority Data
Jun. 29, 2023 (CA) 3205176

(51) Int. Cl. G06Q 30/0282

(52) U.S. Cl. CPC G06Q 30/0282

(57) ABSTRACT

Provided are a system, method, and device for automated customer review moderation. The system includes a review submission module configured to generate or receive review requests from customers after each completed order or invoice payment, an artificial intelligence (AI) based analysis module configured to process content of review submissions received in response to the review requests and identify keywords, phrases, or patterns related to predefined moderation categories, a moderation rules engine including a set of predefined rules for evaluating the content based on the predefined rules and the predefined moderation categories, and an approval/decline module configured to determine that a review is to be approved or declined based on the predefined rules and the predefined moderation categories.

### TECHNICAL FIELD

The following relates generally to systems, methods, and devices for digital customer engagement and feedback management, and more particularly to systems, methods, and devices for digital customer engagement through automating the moderation of customer review submissions using artificial intelligence (AI) techniques.

### INTRODUCTION

Various methods and systems are used for customer review and moderation. In today's digital marketplace, customer reviews have emerged as a key indicator of consumer trust and engagement. Such reviews offer invaluable insights into customer experiences, influencing both the reputations of businesses and the purchasing decisions of prospective buyers. As such, the management and moderation of customer reviews are critical to ensuring the quality and reliability of the feedback shared on public platforms. However, these processes are fraught with challenges, primarily due to the volume of reviews generated and the diverse nature of the content that such reviews include.

Conventional review moderation largely depends on manual efforts. Manual moderation not only requires significant time and resource investment but also introduces the risk of inconsistency and bias in review handling. As businesses strive to maintain an online presence that reflects their commitment to customer satisfaction and transparency, there is a need for an efficient, objective, and scalable solution to review moderation.

Additionally, customer reviews play a key role in shaping brand perception and consumer behavior. Positive reviews may significantly boost sales, while negative feedback may deter potential customers. Therefore, there is a need for a well-managed review ecosystem, where genuine and helpful reviews are promptly highlighted, and inappropriate or misleading content is effectively filtered out. However, existing manual moderation systems are not equipped to handle the volume and complexity of today's review landscape, leading to delays, errors, and inconsistencies in the review publishing process.

Moreover, the subjective nature of manual review moderation may result in the unintentional suppression of valid customer feedback or, conversely, the approval of harmful content. Such outcomes may damage the credibility of the review platform and, by extension, the reputation of the associated business. The challenge is further compounded by the evolving tactics of spammers and malicious actors, who continuously find new ways to bypass traditional moderation mechanisms.

The limitations of manual review moderation highlight a need for a solution that may adapt to the complexities of modern digital interactions. It is desirable not only to efficiently process large volumes of reviews but also to accurately assess the content of the reviews for compliance with established guidelines. This requires a sophisticated understanding of language and context beyond the capability of simple keyword-based filters or manual review alone.

Conventional review moderation systems often experience processing-level inefficiencies due to their reliance on manual or simplistic methods for evaluating review content. Conventional systems are challenged by the vast and diverse nature of data they must analyze, including not only textual content but also images and videos associated with reviews. Manual moderation processes may not scale effectively with the exponential growth of user-generated content on digital platforms. This limitation results in significant delays in review publication, backlog accumulation, and an increased risk of erroneous moderation decisions. Additionally, simplistic automated systems, which typically rely on keyword-based filtering, lack the sophistication to understand the nuanced language of reviews, including idioms, sarcasm, and cultural references. This leads to inaccurate assessments of review appropriateness, where valid feedback may be unjustly removed or inappropriate content incorrectly approved.

The technical challenges of conventional review moderation systems further include their inability to adapt to evolving content trends and moderation standards. Conventional automated systems may not possess the capability to learn from past moderation actions or to adjust their criteria based on emerging patterns of spam, abuse, or other forms of undesirable content. This static approach to moderation fails to account for the dynamic nature of language and human communication, rendering these systems ineffective against sophisticated attempts to circumvent moderation policies. Without the capacity for continuous learning and adaptation, conventional review moderation systems remain ill-equipped to handle the complexity and volume of modern digital communications.

The application of AI technologies to customer review moderation presents a promising solution to the challenges faced by businesses today. AI's ability to process and analyze large datasets with complex patterns allows for a nuanced understanding of text, sentiment, and context, far beyond the capabilities of traditional manual methods. This technological evolution offers the potential to improve the moderation process, enabling not only the automatic identification and filtering of inappropriate content but also the recognition of nuanced and sophisticated attempts at manipulation by malefactors. Accordingly, it is desirable to integrate AI into customer review moderation systems so that businesses may achieve a desired level of efficiency, accuracy, and fairness, ensuring that customer feedback remains a valuable and reliable resource for all stakeholders.

Accordingly, systems, methods, and devices are desired that overcome one or more of the foregoing disadvantages associated with existing customer engagement systems, particularly through providing automated moderation of customer review submissions through AI techniques.

### SUMMARY

A system for automated customer review moderation is provided. The system includes a review submission module configured to generate or receive review requests from customers after each completed order or invoice payment, an AI-based analysis module configured to process content of review submissions received in response to the review requests and identify keywords, phrases, or patterns related to predefined moderation categories, a moderation rules engine including a set of predefined rules for evaluating the content based on the predefined rules and the predefined moderation categories, and an approval/decline module configured to determine that a review is to be approved or declined based on the predefined rules and the predefined moderation categories.

The AI-based analysis module may process the content of the review submissions by representing the content of the review submissions as one or more vector embeddings.

The AI-based analysis module may include a large language model for generating the one or more vector embeddings.

The approval/decline module may determine that the review is to be approved or declined based on the predefined rules and the predefined moderation categories by comparing one or more vector embeddings to the predefined rules and the predefined moderation categories.

The approval/decline module may include a large language module for comparing the one or more vector embeddings to the predefined rules and the predefined moderation categories.

The AI-based analysis module may use Natural Language Processing (NLP) techniques to understand the semantic and contextual meaning of the content of the review submissions.

The set of predefined rules may include a plurality of rules derived from legal and ethical guidelines.

The approval/decline module may automatically publish customer reviews that meet criteria for approval according to the predefined rules and/or the predefined moderation categories.

The approval/decline module may automatically decline reviews that violate the predefined rules.

The AI-based analysis module may continuously learn and improve over time through supervised and unsupervised learning techniques, thereby enhancing accuracy and adaptability.

The content of the review submissions may include textual content, image content, and/or video content.

A method for automated customer review moderation is provided. The method includes receiving review submissions from customers after each completed order or invoice payment, processing the content of the review submissions using AI algorithms, analyzing the content to identify keywords, phrases, or patterns related to predefined moderation categories, evaluating the content based on a set of predefined rules and predefined moderation categories, and approving or declining the review based on the predefined rules and the predefined moderation categories.

Processing the content of the review submissions may include representing the content of the review submissions as one or more vector embeddings.

The method may be implemented, at least in part, on or with a large language model for generating the one or more vector embeddings.

Approving or declining the review may include comparing one or more vector embeddings to the predefined rules and the predefined moderation categories.

The method may be implemented, at least in part, on or with a large language module for comparing the one or more vector embeddings to the predefined rules and the predefined moderation categories.

The method may use Natural Language Processing (NLP) techniques to understand the semantic and contextual meaning of the content of the review submissions.

The set of predefined rules may include a plurality of rules derived from legal and ethical guidelines.

The method may further include automatically publishing customer reviews that meet criteria for approval according to the predefined rules and/or the predefined moderation categories.

The method may further include automatically declining reviews that violate the predefined rules.

The method may include continuously learning and improving over time through supervised and unsupervised learning techniques, thereby enhancing accuracy and adaptability.

The content of the review submissions may include textual content, image content, and/or video content.

A device for automated customer review moderation is provided. The device includes a review submission module configured to generate or receive review requests from customers after each completed order or invoice payment, an AI-based analysis module configured to process content of review submissions received in response to the review requests and identify keywords, phrases, or patterns related to predefined moderation categories, a moderation rules engine including a set of predefined rules for evaluating the content based on the predefined rules and the predefined moderation categories, and an approval/decline module configured to determine that a review is to be approved or declined based on the predefined rules and the predefined moderation categories.

The AI-based analysis module may process the content of the review submissions by representing the content of the review submissions as one or more vector embeddings.

The AI-based analysis module may include a large language model for generating the one or more vector embeddings.

The approval/decline module may determine that the review is to be approved or declined based on the predefined rules and the predefined moderation categories by comparing one or more vector embeddings to the predefined rules and the predefined moderation categories.

The approval/decline module may include a large language module for comparing the one or more vector embeddings to the predefined rules and the predefined moderation categories.

The AI-based analysis module may use Natural Language Processing (NLP) techniques to understand the semantic and contextual meaning of the content of the review submissions.

The set of predefined rules may include a plurality of rules derived from legal and ethical guidelines.

The approval/decline module may automatically publish customer reviews that meet criteria for approval according to the predefined rules and/or the predefined moderation categories.

The approval/decline module may automatically decline reviews that violate the predefined rules.

The AI-based analysis module may continuously learn and improve over time through supervised and unsupervised learning techniques, thereby enhancing accuracy and adaptability.

The content of the review submissions may include textual content, image content, and/or video content.

Other aspects and features will become apparent to those ordinarily skilled in the art, upon review of the following description of some exemplary embodiments.

### BRIEF DESCRIPTION OF THE DRAWINGS

The drawings included herewith are for illustrating various examples of systems, methods, and devices of the present specification. In the drawings:

FIG. 1 is a schematic diagram illustrating a system for automated moderation of customer review submissions, according to an embodiment.

FIG. 2 is a simplified block diagram of a device for automated moderation of customer review submissions, according to an embodiment.

FIG. 3 is a block diagram of a device for automated moderation of customer review submissions, according to an embodiment.

FIG. 4 is a flow chart of a method for automated moderation of customer review submissions, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud based program or system, laptop, personal data assistants, cellular telephone, smartphone, or tablet device.

Each program is preferably implemented in a high-level procedural or object-oriented programming and/or scripting language to communicate with a computer system. However, the programs may be implemented in assembly or machine language, if desired. In any case, the language may be a compiled or interpreted language. Each such computer program is preferably stored on a storage medium or a device readable by a general or special-purpose programmable computer for configuring and operating the computer when the storage medium or device is read by the computer to perform the procedures described herein.

A description of an embodiment with several components in communication with each other does not imply that all such components are required. On the contrary, a variety of optional components are described to illustrate the wide variety of possible embodiments of the present invention.

Further, although process steps, method steps, algorithms, or the like may be described (in the disclosure and/or in the claims) in a sequential order, such processes, methods, and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of more than one device or article.

While the present apparatus and processes have been described with reference to particular embodiments, it should be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

The following relates generally to systems, methods, and devices for digital customer engagement and feedback management, and more particularly to systems, methods, and devices for digital customer engagement through automating the moderation of customer review submissions through the use of artificial intelligence (AI) techniques.

The disclosed automated customer review moderation system provides for management and moderation of customer reviews. Utilizing AI techniques, the system may advantageously efficiently and objectively filter customer review submissions. By automating the moderation workflow, the disclosure addresses the pressing need for a scalable and unbiased approach to review management, ensuring that only genuine and compliant feedback is displayed on business platforms. The automated system is configured to handle vast quantities of reviews, providing a solution that is both time-efficient and consistent in applying moderation policies.

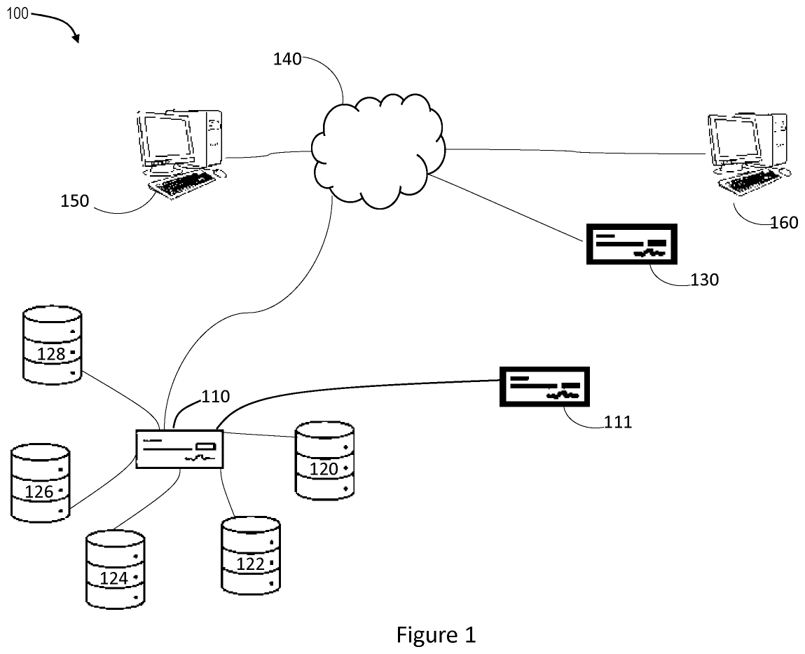

Referring now to FIG. 1, shown therein is a block diagram illustrating a system 100 for automated moderation of customer review submissions, according to an embodiment.

According to an embodiment, the content moderation system 100 includes a content moderation server 110 configured to perform as the central hub for content moderation services. The content moderation server 110 is configured to host key modules including a review submission module 120, an AI-based analysis module 122, a moderation rules module 124, a decision-making module 126, and a display module 128. The content moderation server 110 processes and analyzes review content, applying sophisticated AI and NLP techniques to moderate submissions based on predefined criteria.

The review submission module 120 is configured to interface with a plurality of business platforms 130 including e-commerce sites, point-of-sale systems, and invoicing software. This integration capability of the review submission module 120 facilitates the automatic triggering of review prompts subsequent to customer transactions (e.g., as a customer completes a purchase on a business platform 130, the review submission module provides a form through which the customer provides a review to the content moderation server 110). The automatic triggering may mediate through communication protocols and APIs that enable real-time data exchange between the review submission module 120 and the plurality of business platforms 130.

The technical operations underlying the review prompts may include deployment of event-driven programming models. Specific transactional events such as the completion of a purchase or the processing of a payment may serve as triggers for the generation of review requests. The review requests may be dynamically created and personalized based on the transaction details, utilizing templating engines and customizable workflows to ensure that prompts, forms, and the like are both relevant and contextually appropriate to the customer's recent experience. The review submission module 120 may employ advanced web technologies, including AJAX, to deliver the prompts asynchronously, thereby ensuring that the customer's interaction with the business platform remains uninterrupted and fluid.

Furthermore, the review submission module 120 may incorporate user interface (UI) and user experience (UX) design principles to optimize the presentation and accessibility of the review prompts. A plurality of responsive design techniques may be provided to ensure compatibility across a wide range of devices and screen sizes, as well as the implementation of accessibility standards to accommodate all users. The review submission module 120 may include mechanisms for tracking user engagement with the review prompts, employing cookies and local storage to record and analyze response rates and patterns. The user engagement data may subsequently be used to refine the timing, appearance, and content of future review prompts, ensuring that the submission of feedback remains as unobtrusive and user-friendly as possible.

The AI-based analysis module 122 is configured to use Natural Language Processing (NLP) techniques for parsing review submissions. The AI-based analysis module 122 systematically breaks down and interprets the semantic and contextual nuances embedded within the text of reviews received via the review submission module 110. The foregoing may include the application of syntactic analysis, sentiment analysis, and entity recognition algorithms that enable the AI-based analysis module 122 to grasp the underlying meanings and intentions of words and phrases within various contexts.

The AI-based analysis module 122 provides for identification of review content that aligns with pre-established moderation categories. The pre-established moderation categories may include, but are not limited to, spam, hate speech, and other forms of content deemed inappropriate for publication. Through the deployment of machine learning models and NLP frameworks, the AI-based analysis module 122 may provide for a capability to go beyond mere surface-level analysis offered by traditional keyword-based filtering systems. The AI-based analysis module is configured for analyzing patterns of language use, the structure of sentences, and the contextual alignment of terms, which collectively contribute to a more nuanced understanding of the content of the reviews received via the review submission module 110.

The AI-based analysis module 122 is further configured to apply sophisticated algorithms to evaluate the intent behind customer feedback, distinguishing between genuine reviews and those attempting to manipulate or undermine the integrity of any of the plurality of business platforms 130 and/or the reviews. The employment of advanced NLP techniques enables the content moderation server 110 to assess the relevance and appropriateness of submissions, efficiently sorting and categorizing the submissions into the corresponding pre-established moderation category. The foregoing enables the content moderation server 110 to accurately and reliably moderate the submissions received from the plurality of business platforms 130 via the review submission module 120, maintaining a high standard of quality and relevance in the feedback displayed to users.

The AI-based analysis module 122 is further configured to apply NLP to parse text and extract semantic and contextual meanings. This functionality allows the AI-based analysis module 122 to identify content within specific moderation categories such as spam or hate speech. By employing NLP techniques, the AI-based analysis module 122 may interpret the intent and context of the feedback, overcoming the constraints of traditional keyword filters.

Additionally, the AI-based analysis module 122 may further be configured to understand language nuances such as sarcasm, intent, and sentiment through NLP. Such further configuration advantageously enables the AI-based analysis module 122 to categorize reviews accurately based on predefined moderation criteria. Accordingly, the AI-based analysis module 122 assesses not only individual words but also the overall message and tone of the review provided to the review submission module 120.

The design of the AI-based analysis module 122 focuses on comprehensive text analysis. Such analysis supports precise categorization by considering both the explicit content and the subtler aspects of communication conveyed in reviews.

The content moderation server 110 includes the moderation rules module 124. The moderation rules module 124 is configured to enforce a comprehensive set of rules. In an embodiment, the rules originate from a blend of legal requirements, ethical standards, and specific business guidelines. The moderation rules module 124 provides for a systematic rule-based framework to review content. This framework provides that each piece of content undergoes evaluation against a uniform set of criteria, thereby aiming to streamline the moderation and remove bias through consistent application of the uniform set of criteria.

The moderation rules module 124 operates by parsing incoming review submissions (as received via the review submissions module 120) and matching the content therein against a database of the foregoing rules (not shown). Each rule within the framework is encoded with specific conditions that review submissions may meet or avoid. For instance, rules may target the presence of certain keywords indicative of spam or hate speech, patterns suggesting fraudulent content, or the absence of elements that confirm the review's relevance to the product or service. This rules-based approach enables the moderation rules module 124 to categorize and flag reviews for further action based on predefined parameters.

Additionally, the moderation rules module 124 is further configured to adapt to a wide array of moderation criteria. This adaptability extends to the capability to update and refine the rules over time, responding to evolving legal landscapes, ethical considerations, and business priorities. The moderation rules module 124 supports dynamic adjustments to its rule set, facilitating the integration of new rules or the modification of existing ones to better align with current moderation needs. Through this adaptive mechanism, the moderation rules module 124 remains effective in maintaining the relevance and integrity of the review moderation.

The foregoing rules establish a foundation for the moderation that is both consistent and equitable. The moderation rules module 124 is configured to integrate with a diverse spectrum of rules, each tailored to assess customer reviews. The assessment criteria may focus on the appropriateness, relevance, and compliance of the review content, ensuring that each piece of feedback aligns with the predefined standards.

The construction of the rules and associated framework within the moderation rules module 124 leverages legal and ethical principles as a baseline, thereby structuring a moderation environment that upholds brand integrity while simultaneously respecting customer rights and expectations. This methodical approach to rule formulation within the moderation rules module 124 facilitates moderation based on fairness and accountability. Through this framework, the moderation rules module 124 effectively navigates the complex landscape of review moderation, balancing the imperative to maintain a positive and authentic online presence with the ethical considerations and legal constraints that govern digital content.

Moreover, the technical functionality performed by the moderation rules module 124 includes the systematic application of these rules to the review content processed by the AI-based analysis module 122. Such application includes algorithmic checks and balances, according to which each review submission is scanned and evaluated against the foregoing comprehensive rule set. The operational logic of the moderation rules module 124 enables dynamic adaptation to varying criteria, which may evolve in response to changes in legal standards, ethical norms, or business policies. This adaptive capability ensures that the moderation rules module 124 remains effective and relevant, irrespective of the shifting digital landscape or emerging trends in consumer feedback.

The decision-making module 126 is configured to assess the suitability of each review for publication.

The decision-making module 126 leverages analyses conducted by the AI-based analysis module 122, which employs NLP techniques to scrutinize review content. This involves a detailed examination of the text of each review submission received by the review submissions module 120 to detect nuances and context, aligning the reviews with predefined categories and moderation rules established in the moderation rules module 124.

The decision-making module 126 automates the approval of reviews that align with moderation policies and rejects those that do not. The decision-making module 126 provides for a detailed comparison of the AI's content evaluation results with the moderation rules set by the moderation rules module 124. This comparison utilizes algorithms to match review content features with criteria specified in the moderation policies. If review content meets the established criteria, the decision-making module 126 triggers an approval workflow; conversely, if content breaches any rule, a rejection workflow is initiated (not shown).

The decision-making module 126 operates through a series of logical checks and balances designed to ensure each review is accurately categorized as compliant or non-compliant. The decision-making module 126 integrates with the AI-based analysis and moderation rules framework, streamlining the moderation by facilitating swift and precise decision-making on review publication status.

The decision-making module 126 serves as the conclusive authority within the review moderation framework of the content moderation server 110. The decision-making module 126 is configured to provide autonomous publication or rejection of customer reviews, following a binary pathway: reviews aligning with the approval standards are published, while those infringing upon moderation policies are declined. The basis for these outcomes is a thorough evaluation conducted by the AI-based analysis module 122, which applies the foregoing NLP techniques to dissect and understand the review content in relation to the standards outlined by the moderation rules module 124.

The operation performed by the decision-making module 126 is characterized by its reliance on outputs from the AI-based analysis module 122, which processes textual review content to discern its eligibility against the predefined moderation framework. This analysis is compared against the criteria delineated by the moderation rules module 124, ensuring that the decision to publish or decline a review is grounded in a comprehensive understanding of both the content's semantic meaning and its adherence to legal and ethical guidelines.

Through the automation of decision-making, the decision-making module 126 enhances the efficiency of review moderation, significantly reducing the time span from submission of a review to the review submission module 120 (e.g., via one of the plurality of business platforms 130) to publication or rejection. This systematic approach not only accelerates the moderation workflow but also mitigates potential human biases, thereby ensuring the publication of reviews that accurately reflect compliant and suitable feedback and the rejection of reviews that do not.

The content moderation server 110 incorporates AI algorithms designed to facilitate continuous learning and improvement, leveraging both supervised and unsupervised learning techniques. These algorithms operate within the AI-based analysis module 122 in order to continuously analyze and learn from patterns and outcomes in a dataset comprising previously moderated reviews. Supervised learning involves the algorithms being trained on a labeled dataset, where each review is marked as either approved or declined, teaching the AI to recognize patterns associated with each outcome. Unsupervised learning, on the other hand, allows the AI to explore the data without predefined labels, enabling it to uncover hidden structures and relationships within the review content.

Underpinning this continuous learning mechanism is the collection and preprocessing of review data, where text is cleaned, normalized, and transformed into a format suitable for machine learning models. The AI-based analysis module 122 then applies NLP techniques to extract features from the reviews, such as sentiment, thematic elements, and linguistic patterns. These features form the basis for both training the machine learning models in supervised learning scenarios and for the exploratory analysis in unsupervised learning contexts.

Once the feature extraction is complete, the AI-based analysis module 122 employs machine learning algorithms to analyze these features in the context of the review moderation criteria set forth by the moderation rules module 124. In supervised learning, the algorithms adjust their parameters to minimize the difference between the predicted and actual outcomes, refining their ability to classify reviews accurately. In unsupervised learning, clustering and anomaly detection techniques help identify novel or unexpected patterns in review content, which can inform adjustments to the moderation rules or highlight emerging trends in user feedback.

The iterative learning is supported by a feedback loop, where the outcomes of the moderation (i.e., reviews being approved or declined) are fed back into the system 100 to further refine the learning models. This feedback mechanism ensures that the algorithms performed or deployed at or by the AI-based analysis module 122 continue to evolve in response to new data, enhancing the capacity of the system 100 to adapt to changes in language use, review content trends, and moderation standards over time.

Through this comprehensive and ongoing learning paradigm, the content moderation server 110 provides that its moderation capabilities remain current and effective against an ever-evolving backdrop of user-generated content. The use of both supervised and unsupervised learning techniques allows the system 100 to not only maintain its accuracy and adaptability in moderating customer reviews but also to anticipate and respond to new challenges, ensuring the long-term reliability and scalability of the moderation system 100.

The display module 128 is configured to provide features such as a screen share and review management interface (not shown), allowing administrators to oversee the moderation. Once published, reviews may be held in a pending state for a predetermined period, during which an administrator has the opportunity to approve or decline the submission manually. The interface may also provide for the moderation of images submitted as part of reviews, ensuring that all forms of customer feedback are subjected to thorough scrutiny. The decision to decline a submission may be communicated to the customer for transparency and feedback in the moderation.

According to an embodiment, the content moderation server 110 is connected to a database 120. The database 120 stores a comprehensive dataset that includes review submissions, moderation decisions, and the extensive set of moderation rules and criteria established within the moderation rules module 124. The database 111 may be a relational database structured to facilitate quick retrieval of information, supporting the dynamic and real-time nature of the moderation. The design of the database 111 ensures that data integrity and consistency are maintained, employing transactional protocols to handle concurrent operations and updates to the dataset.

In addition to storing historical moderation data, the database 111 provides for the continuous learning aspect of the AI-based analysis module 122. The database 111 archives outcomes of moderated reviews, which serve as training data for supervised and unsupervised learning models. This enables the AI algorithms to evolve and adapt over time, enhancing their accuracy and effectiveness in identifying content that meets or violates moderation standards. The flexible schema of the database 111 allows for the incorporation of new moderation rules and the adjustment of existing ones, ensuring that the system 100 can respond swiftly to changes in legal, ethical, or business-specific moderation requirements. Connection to the content moderation server 110 is secured through encrypted channels, safeguarding the confidentiality and security of the stored data.

The content moderation system 100 includes the plurality of business platforms 130 including e-commerce sites, point-of-sale systems, and invoicing software. Each business platform 130 may be a merchant server 130 or a merchant platform 130. For convenience of reference, the terms business platform 130, merchant server 130, and merchant platform 130 are used interchangeably, in the singular or the plural, throughout the present disclosure, and each instance of one of the foregoing terms should be understood to further bear the meaning of the other foregoing terms except where context indicates otherwise.

Each platform 130 may be used by businesses to sell products and services and interact with customers. The merchant servers 130 are connected to the content moderation server 110 via the communication network 140, facilitating a seamless flow of information and data related to customer reviews. In particular, the merchant servers 130 send the customer reviews to the review submissions module 120 of the server 110 or are configured to enable to review submissions module 120 to request and receive the customer reviews.

Following a customer transaction, the merchant platform 130 may generate review prompts based on triggers from the review submission module 120 in the content moderation server 110. These prompts are customized and sent to customers, encouraging them to submit feedback on their recent transactions or experiences.

Once a customer submits a review, the merchant platform 130 collects this data, including any textual content, ratings, and possibly images or videos, and forwards it to the content moderation server 110 for processing. This may provide for gathering the raw input that will undergo moderation.

After the content moderation server 110, specifically the decision-making module 126, has processed and determined the appropriateness of a review (either approving for publication or declining), this decision is communicated back to the merchant platform 130. The platform 130 then updates the review's status accordingly, displaying approved reviews to the public or removing/flagging content as needed.

The merchant platform 130 integrates with the content moderation server 110 through the secure and efficient communication network 140, which supports real-time transfer of review submissions from the merchant platform 130 to the content moderation server 110 and the provision of moderation decisions from the content moderation server 110 to the merchant platform 130. Furthermore, the network 140 utilizes application programming interfaces (APIs) and standardized communication protocols to enable interoperability and seamless data exchange between the merchant platform 130 and the content moderation server 110. The network 140 may further implement encryption and data protection measures to safeguard sensitive customer information and review content during transmission and processing.

The system 100 further includes an administrator terminal 150. The administrator terminal 150 provides the interface for administrators and users to interact with the content moderation system 110. The administrator terminal 150 enables real-time oversight and control over the review moderation. Through this interface, administrators may access functionalities such as manual review approval or rejection, review status monitoring, and moderation rule configuration. The user terminal is designed with a focus on ease of use and efficiency, incorporating advanced user interface (UI) and user experience (UX) design principles. Responsive design techniques ensure that the interface is accessible across a wide range of devices, from desktop computers to mobile phones, facilitating seamless interaction regardless of the user's device.

Furthermore, the administrator terminal 150 includes mechanisms for detailed analytics and reporting, providing insights into the effectiveness of the moderation, patterns in user engagement with review prompts, and trends in review content. These analytics tools allow administrators to make data-driven decisions to refine and optimize the review moderation strategy. The administrator terminal 150 connects to the content moderation server 110 via the secure communication network 140, ensuring that all interactions and data transmissions are protected against unauthorized access and data breaches.

The system 100 further includes a user terminal 160. The user terminal 160 provides the interface through which customers interact with the review system 100 to submit their feedback on products or services. The user terminal 160 may be designed to offer a user-friendly and intuitive experience, encouraging customers to share their insights and experiences. Employing advanced web technologies and adhering to the latest UI/UX design principles, the user terminal 160 provides that submitting a review is straightforward and accessible. The interface is optimized for compatibility across a diverse array of devices, including smartphones, tablets, and desktop computers, enabling customers to leave reviews conveniently, regardless of the device used. This inclusivity in design guarantees that all customer segments can provide reviews effortlessly, enhancing the volume and diversity of feedback collected.

Within the user terminal 160, customers are presented with dynamically generated review prompts that are contextually relevant to their recent transactions. These prompts are the result of seamless integration with the business platforms 130 via the review submission module 120, which triggers the review request following a customer's transaction. To ensure a smooth and engaging review experience, the user terminal 160 includes features such as auto-save drafts, the ability to upload multimedia content, and real-time validation of input to guide customers in providing useful and comprehensive feedback. The user terminal 160 also employs secure communication protocols to protect the privacy and integrity of the data submitted by users. Through these technical and operational considerations, the user terminal 160 provides for facilitating the collection of valuable customer reviews, serving as the initial touchpoint in the system 100.

The administrator terminal 150 may enable AI moderation settings that include some or all of the foregoing functionality, e.g., by selectively enabling an “AI moderation” functionality, for example by clicking a button on a UI. When the foregoing functionality is enabled, artificial intelligence tools are activated to autonomously moderate both positive and negative reviews for an extended period according to the foregoing functionality, granting merchants additional time to address the content. If a review remains unaddressed by the merchant within this timeframe, the AI intervenes to determine the appropriateness of the review for publication.

The system 100 extends its moderation capabilities to include the analysis of images and videos within reviews. Utilizing proprietary logic, the AI assesses visual content for the presence of inappropriate or unacceptable material, such as spam or offensive imagery. This ensures comprehensive moderation coverage that encompasses not only textual but also visual customer feedback.

The determination of whether a review is to be approved or declined is supported by a preset logic, which considers historical moderation patterns and merchant-specific preferences. The system 100 employs vector embeddings to represent review content in a multidimensional space, facilitating the comparison of new submissions against a database of previously moderated reviews. This similarity approach allows the AI underpinning the system 100 to gauge the likelihood of a review's compliance based on its resemblance to known content categories.

In an embodiment, the system 100 leverages conversational requests with a Large Language Model (LLM) to integrate comprehensive context in the moderation decision-making. By considering the content of the review, information about the reviewer, similarities to previous reviews, and specific details about the store and merchant actions, the LLM assesses the submission in a holistic manner. This approach enables a nuanced evaluation that incorporates both the explicit content of the review and its implicit implications within the broader context of the store's moderation history and guidelines.

In an embodiment, the system 100 incorporates non-LLM based algorithms (e.g., to generate vector embeddings, to perform a comparison of semantic similarity in reviews) to ensure broad applicability and versatility in the moderation decision-making process. Specifically, the system 100 applies predetermined rules and identifies explicit content patterns, enabling the system to make moderation decisions based on clear criteria and observable data points. The non-LLM embodiment ensures the functionality of the system 100 remains robust across various operational contexts, providing an alternative means of content evaluation that complements the depth of LLM analysis with the specificity of rule-based approaches.

In a non-LLM embodiment, system 100 employs a combination of deterministic and probabilistic algorithms to perform content moderation other than vector embeddings. The embodiment may utilize machine learning models such as Support Vector Machines (SVMs), decision trees, and Naïve Bayes classifiers, alongside rule-based filtering systems, to analyze and moderate review content (e.g., providing previously approved or declined customer review submissions to the foregoing machine learning algorithms or computer products implementing same. Deterministic algorithms may apply a set of explicit rules derived from legal, ethical, and business-specific guidelines to evaluate the text. These rules may include keyword matching for specific terms associated with spam or offensive content, pattern recognition for identifying irregular posting behaviors, and syntax analysis for assessing the grammatical integrity of the submissions. Further examples include neural networks and other examples of artificial intelligence and machine learning more generally.

In an embodiment, the system 100 provides a similarity approach for automated customer review moderation, leveraging the power of AI to create vector embeddings. These embeddings are AI-generated data vectors that encapsulate the content's essence, transforming textual and visual feedback into a format understandable by machines. Each piece of content, upon submission, is converted into a vector embedding, which is then analyzed to ascertain its similarity to existing content within the system's database. The foregoing does not rely solely on the Large Language Model (LLM) for comparison but employs an algorithm to measure the degree of similarity between vectors. Such a mechanism allows for the efficient identification of content that bears resemblance to previously moderated reviews, streamlining the moderation by leveraging historical data patterns.

In an aspect, the foregoing uses the LLM.

In an aspect, the foregoing does not use or rely on the LLM.

The utilization of the LLM in generating vector embeddings introduces a layer of sophistication in identifying content similarities. Unlike traditional models that might only compare textual similarities at a superficial level, the LLM approach considers the semantic and contextual nuances of the content. This means that even if two reviews are expressed in completely different languages or styles, their underlying meanings may be captured and compared through the generated vectors. This advanced analysis ensures a more accurate and nuanced understanding of content, enhancing the capability of the system 100 to moderate reviews based on deep semantic similarities rather than mere keyword matching.

In addition to the similarity approach, the system 100 incorporates standard checks to further refine the moderation. The checks scrutinize reviews for elements such as unrelated links, spam, or previously identified inappropriate content. By integrating these standard evaluations with advanced AI analysis, the system 100 ensures a comprehensive review of submissions, filtering out undesirable content based on a multi-faceted assessment criteria.

In an embodiment, the system 100 leverages conversational requests with the LLM. This feature includes presenting the LLM with detailed context surrounding a review, including the content, information about the reviewer, similarities to previous reviews, store category, and merchant's historical moderation decisions. By synthesizing the wealth of information, the LLM may make informed decisions regarding the suitability of a review for publication. This approach allows for a tailored moderation that considers not just the content of the review itself but its relevance and potential impact within the specific context of the store and its moderation history.

The decision-making employed by the system 100 is designed to improve accuracy and fairness. Reviews are evaluated against a set of moderation categories, with the LLM calculating the probability of a review falling within these categories. Depending on this probability, reviews are either approved, kept pending for further review, or automatically declined. This methodological evaluation ensures that each review is subjected to a thorough and objective assessment, minimizing the risk of inappropriate content being published while fostering a transparent and trustworthy environment for customer feedback.

In an embodiment, the decision-making functionality incorporates a conversational interaction with a Large Language Model (LLM) to analyze review submissions in conjunction with contextual information. This involves presenting the LLM with the review text, details about the customer, and comparisons with the three most similar reviews, which may be identified through vector embeddings to ascertain content similarity. Additionally, information regarding the store category, as well as the last three reviews each approved and declined by the merchant, are provided to enrich the context. The LLM is then queried to assess the review's compliance with predefined moderation criteria, considering the comprehensive context.

In the foregoing embodiment, the LLM evaluates the submission's alignment with categories that warrant denial, quantifying the certainty of each categorization with a percentage. The decision to approve, leave pending, or reject the review is based on these percentages. Reviews with less than a 0.1% probability of falling into any denial category are approved. Submissions identified with a probability between 0.1% and approximately 99% with respect to any such category are marked as pending, triggering manual review. If the probability exceeds 99% for any specific category, the review is automatically rejected. This detailed statistical assessment enables nuanced moderation decisions, reflecting the complexity of human language and contextual nuances.

In an embodiment, the decision-making functionality does not include vector embeddings and LLMs. This embodiment includes a direct comparison of the current review submission against the most recent reviews that have been approved or declined by the merchant. The embodiment may not employ vector embeddings to determine similarity but instead analyzes patterns, keywords, and topics directly from the recent review history.

While conventional NLP is only able to consider actual words used, the moderation systems, methods, and devices of the present disclosure may further consider the meaning underlying the content of reviews. The advantages of the present disclosure may further include iterative improvements, as greater use of the foregoing disclosed systems, methods, and devices may cause the systems, methods, and devices to demonstrate improvements in accuracy, efficiency, and otherwise.

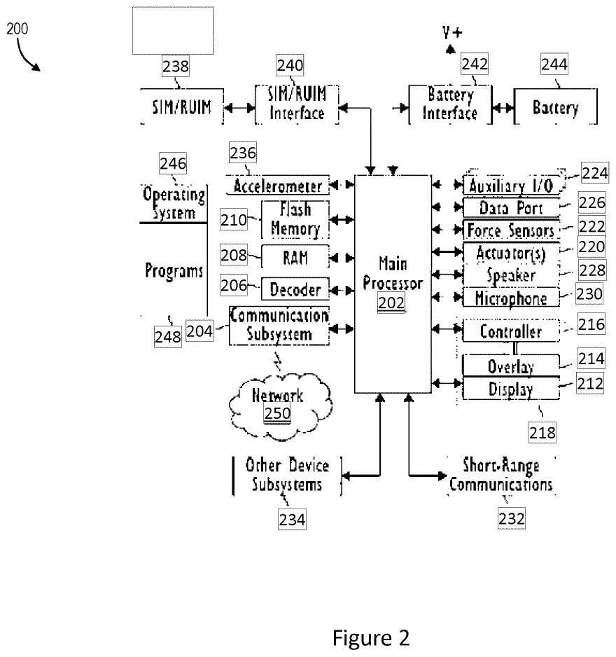

Referring now to FIG. 2, shown therein is a simplified block diagram of a device 200 for automated moderation of customer review submissions, according to an embodiment.

The device 200 may be for example any of the devices shown in FIG. 1. The device 200 includes a processor 202 that controls the operations of the device 200. Communication functions, including data communications, voice communications, or both may be performed through a communication subsystem 204. The communication subsystem 204 may receive messages from, and send messages to, a wireless network 250. Data received by the device 200 may be decompressed and decrypted by a decoder 206.

The wireless network 250 may be any type of wireless network, including, but not limited to, data-centric wireless networks, voice-centric wireless networks, and dual-mode networks that support both voice and data communications.

The device 200 may be a battery-powered device and as shown includes a battery interface 242 for connecting one or more rechargeable batteries 244.

The processor 202 also interacts with additional subsystems such as a Random Access Memory (RAM) 208, a flash memory 210, a display 212 (e.g. with a touch-sensitive overlay 214 connected to an electronic controller 216 that together comprise a touch-sensitive display 218), an actuator assembly 220, one or more optional force sensors 222, an auxiliary input/output (I/O) subsystem 224, a data port 226, a speaker 228, a microphone 230, short-range communications systems 232 and other device subsystems 234.

In some embodiments, user-interaction with the graphical user interface may be performed through the touch-sensitive overlay 214. The processor 202 may interact with the touch-sensitive overlay 214 via the electronic controller 216. Information, such as text, characters, symbols, images, icons, and other items that may be displayed or rendered on a portable electronic device generated by the processor 202 may be displayed on the touch-sensitive display 218.

The processor 202 may also interact with an accelerometer 236 as shown in FIG. 2. The accelerometer 236 may be utilized for detecting direction of gravitational forces or gravity-induced reaction forces.

To identify a subscriber for network access according to the present embodiment, the device 200 may use a Subscriber Identity Module or a Removable User Identity Module (SIM/RUIM) card 238 inserted into a SIM/RUIM interface 240 for communication with a network (such as the wireless network 250). Alternatively, user identification information may be programmed into the flash memory 210 or performed using other techniques.

The device 200 also includes an operating system 246 and software components 248 that are executed by the processor 202 and which may be stored in a persistent data storage device such as the flash memory 210. Additional applications may be loaded onto the device 200 through the wireless network 250, the auxiliary I/O subsystem 224, the data port 226, the short-range communications subsystem 232, or any other suitable device subsystem 234.

For example, in use, a received signal such as a text message, an e-mail message, web page download, or other data may be processed by the communication subsystem 204 and input to the processor 202. The processor 202 then processes the received signal for output to the display 212 or alternatively to the auxiliary I/O subsystem 224. A subscriber may also compose data items, such as e-mail messages, for example, which may be transmitted over the wireless network 250 through the communication subsystem 204.

For voice communications, the overall operation of the device 200 may be similar. The speaker 228 may output audible information converted from electrical signals, and the microphone 230 may convert audible information into electrical signals for processing.

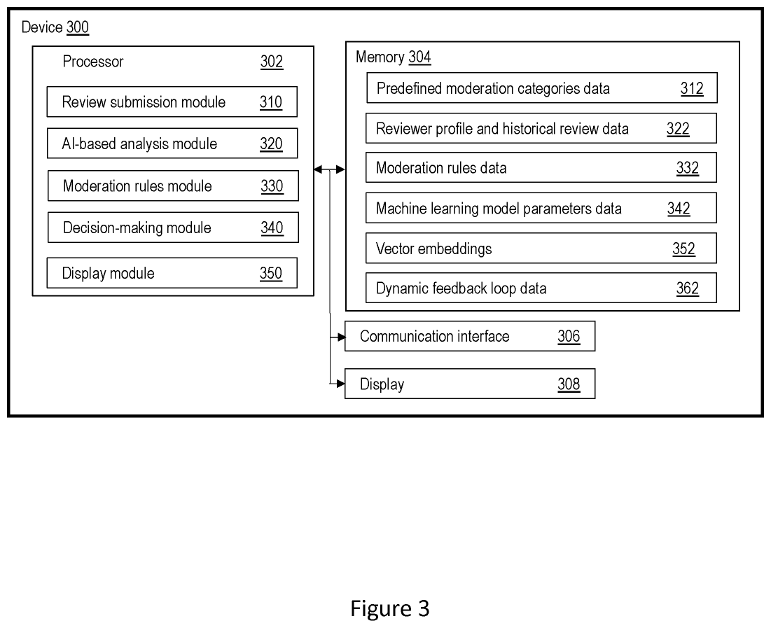

Referring now to FIG. 3, shown therein is a block diagram of a device 300 for automated moderation of customer review submissions, according to an embodiment. The device 300 may be the content moderation server 110 of FIG. 1.

The device 300 includes a processor 302, a memory 304, a communication interface 306 for interacting with the end user, and a display 308.

The processor 302 includes a review submission module 310. The review submission module 310 of FIG. 3 may be the review submission module 120 of FIG. 1. The review submission module 310 is configured to interface with a plurality of business platforms including e-commerce sites, point-of-sale systems, and invoicing software. The integration capability of the review submission module 310 facilitates the automatic triggering of review prompts subsequent to customer transactions. The automatic triggering is mediated through communication protocols and APIs that enable real-time data exchange between the review submission module and the aforementioned business platforms.

The technical operations underlying the review prompts may include deployment of event-driven programming models. Specific transactional events such as the completion of a purchase or the processing of a payment may serve as triggers for the generation of review requests. The review requests may be dynamically created and personalized based on the transaction details, utilizing templating engines and customizable workflows to ensure that the prompts are both relevant and contextually appropriate to the customer's recent experience. The review submission module 310 may employ advanced web technologies, including AJAX, to deliver the prompts asynchronously, thereby ensuring that the customer's interaction with the business platform remains uninterrupted and fluid.

Furthermore, the review submission module 310 may incorporate user interface (UI) and user experience (UX) design principles to optimize the presentation and accessibility of the review prompts. A plurality of responsive design techniques may be provided to ensure compatibility across a wide range of devices and screen sizes, as well as the implementation of accessibility standards to accommodate all users. The review submission module 310 may include mechanisms for tracking user engagement with the review prompts, employing cookies and local storage to record and analyze response rates and patterns. The user engagement data is subsequently used to refine the timing, appearance, and content of future review prompts, ensuring that submitting feedback remains as unobtrusive and user-friendly as possible.

The device 300 further includes an AI-based analysis module 320. The AI-based analysis module 320 of FIG. 3 may be the AI-based analysis module 122 of FIG. 1. The AI-based analysis module 320 is configured to utilize NLP techniques for parsing review submissions. The AI-based analysis module 320 systematically breaks down and interprets the semantic and contextual nuances embedded within the text of reviews. This technical functionality may involve the application of syntactic analysis, sentiment analysis, and entity recognition algorithms that enable the AI-based analysis module 320 to grasp the underlying meanings and intentions of words and phrases within various contexts.

The AI-based analysis module 320 provides for identification of review content that aligns with pre-established moderation categories according to predefined moderation categories data 312 stored in the memory 304. The pre-established moderation categories may include, but are not limited to, spam, hate speech, and other forms of content deemed inappropriate for publication. Through the deployment of machine learning models and NLP frameworks, the AI-based analysis module 320 may provide for a capability to go beyond mere surface-level analysis offered by traditional keyword-based filtering systems. The AI-based analysis module 320 is configured for analyzing patterns of language use, the structure of sentences, and the contextual alignment of terms, which collectively contribute to a more nuanced understanding of the content.

Furthermore, the AI-based analysis module 320 is configured to apply sophisticated algorithms to evaluate the intent behind customer feedback, distinguishing between genuine reviews and those attempting to manipulate or undermine the integrity of the review platform. The use of advanced NLP techniques enables device 300 to assess the relevance and appropriateness of submissions (considering reviewer profile and historical review data 322 stored in the memory 304), efficiently sorting and categorizing the submissions into the corresponding moderation categories according to the predefined moderation categories data 360. This comprehensive analysis ensures that the device 300 accurately and reliably moderates review content, maintaining a high standard of quality and relevance in the feedback displayed to users.

In an embodiment, the AI-based analysis module 320 is configured to apply NLP to parse text and extract semantic and contextual meanings. This functionality allows the AI-based analysis module 320 to identify content within specific moderation categories such as spam or hate speech. By employing NLP techniques, the AI-based analysis module 320 can interpret the intent and context of the feedback, overcoming the constraints of traditional keyword filters.

Additionally, the AI-based analysis module 320 is configured to understand language nuances such as sarcasm, intent, and sentiment through NLP. This functionality enables the AI-based analysis module 320 within the device 300 to categorize reviews accurately based on predefined moderation criteria. The AI-based analysis module 320 assesses not just individual words but further the overall message and tone of the review.

The design of the AI-based analysis module 320 focuses on comprehensive text analysis. This analysis supports precise categorization by considering both the explicit content and the subtler aspects of communication conveyed in reviews.

The device 300 further includes a moderation rules module 330. The moderation rules module 330 of FIG. 3 may be the moderation rules module 124 of FIG. 1. The moderation rules module 330 is configured to enforce a comprehensive set of rules stored as moderation rules data 332 in the memory. These rules originate from a blend of legal requirements, ethical standards, and specific business guidelines. The moderation rules module 330 provides for a systematic rule-based framework to review content. This structured approach ensures that each piece of content undergoes evaluation against a uniform set of criteria, thereby aiming to streamline the moderation.

The moderation rules module 330 operates by parsing incoming review submissions and matching the content against the moderation rules data 332 (which may be, e.g., a rules database). Each rule within the rules database is encoded with specific conditions that review content may meet or avoid. For instance, rules may target the presence of certain keywords indicative of spam or hate speech, patterns suggesting fraudulent content, or the absence of elements that confirm the review's relevance to the product or service. This functionality enables the moderation rules module 330 to categorize and flag reviews for further action based on predefined parameters.

Additionally, the moderation rules module 330 is further configured to adapt to a wide array of moderation criteria. This adaptability extends to the capability to update and refine rules over time, responding to evolving legal landscapes, ethical considerations, and business priorities. The moderation rules module 330 supports dynamic adjustments to its rule set (e.g., as stored in the rules database), facilitating the integration of new rules or the modification of existing rules to better align with current moderation needs. Through this adaptive mechanism, the moderation rules module 330 remains effective in maintaining the relevance and integrity of the review moderation. In an embodiment, the moderation rules 332 and the predefined moderation categories data 312 are received by the communication interface 306.

The construction of the rules within the moderation rules module 330 leverages legal and ethical principles as a baseline, thereby structuring a moderation environment that upholds brand integrity while simultaneously respecting customer rights and expectations. This methodical approach to rule formulation within the moderation rules module 330 facilitates a moderation practice based on fairness and accountability. Through this framework, the moderation rules module 330 effectively navigates the complex landscape of review moderation, balancing the imperative to maintain a positive and authentic online presence with the ethical considerations and legal constraints that govern digital content.

Moreover, the technical functionalities performed by the moderation rules module 330 include the systematic application of the foregoing rules to the review content processed by AI-based analysis module 320 according to machine learning model parameters data 342 stored in the memory 304. The application of the machine learning model parameters data 342 includes algorithmic checks and balances, whereby each review submission is scanned and evaluated against the comprehensive setoff the moderation rules 330 (e.g., based on the moderation rules data 332 as amended according to the foregoing). The operational logic of the moderation rules module 330 enables dynamic adaptation to varying criteria, which may evolve in response to changes in legal standards, ethical norms, or business policies. This adaptive capability ensures that the moderation rules module 330 remains effective and relevant, irrespective of the shifting digital landscape or emerging trends in consumer feedback.

The device 300 further includes a decision-making module 340. The decision-making module 340 is configured to assess the suitability of each review for publication. The decision-making module 340 of FIG. 3 may be the decision-making module 126 of FIG. 1.

The decision-making module 340 leverages analyses conducted by the AI-based analysis module 320, which employs NLP techniques to scrutinize review content, and applies the machine learning model parameters data 342. This involves a detailed examination of the text to detect nuances and context, aligning the text with predefined categories and moderation rules established in the moderation rules module 330.

In the preferred embodiment where vector embeddings are used, the vector embeddings are stored at vector embeddings 352 in the memory 304.

The decision-making module 340 automates the approval of reviews that align with moderation policies and rejects those that do not. The decision-making module 340 provides for a detailed comparison of the AI's content evaluation results with the moderation rules set by moderation rules module 330 (e.g., through the use of the vector embeddings 352). This comparison utilizes algorithms to match review content features with criteria specified in the moderation policies (e.g., using an LLM as hereinabove discussed). If review content meets the established criteria, the decision-making module 340 triggers an approval workflow; conversely, if content breaches any rule, a rejection workflow is initiated.

The decision-making module 340 operates through a series of logical checks and balances designed to ensure each review is accurately categorized as compliant or non-compliant. The decision-making module 340 integrates with the AI-based analysis and moderation rules framework, streamlining the moderation by facilitating swift and precise decision-making on review publication status.

In an embodiment, the decision-making module 340 serves as the conclusive authority within the review moderation framework of the device 300. The decision-making module 340 is configured to provide autonomous publication or rejection of customer reviews, following a binary pathway: reviews aligning with the approval standards are published, while those infringing upon moderation policies are declined. The basis for these outcomes is a thorough evaluation conducted by the AI-based analysis module 320, which applies NLP to dissect and understand the review content in relation to the standards outlined by the moderation rules module 330.

The operations performed by the decision-making module 340 are characterized by reliance on the outputs of the AI-based analysis module 320, which processes textual review content to discern its eligibility against the predefined moderation framework. This analysis is compared against the criteria delineated by the moderation rules module 330, ensuring that the decision to publish or decline a review is grounded in a comprehensive understanding of both the content's semantic meaning and its adherence to legal and ethical guidelines.

Where input or feedback as to the quality of customer review moderation is provided (e.g., customer appeals of review rejection, feedback from an administrator), such input or feedback and any computational operations thereon (e.g., further machine learning models or LLM's trained with respect to such input or feedback) is stored as dynamic feedback loop data 362 in the memory 304. The dynamic feedback loop data 362 may be used by any of the modules of the processor 302 in order to improve review moderation.

The predefined moderation categories data 312 includes a detailed list of categories such as spam, hate speech, and other forms of inappropriate content. These categories serve as the foundation for the AI-based analysis module 320 to evaluate the review submissions. The data 360 is dynamically updatable, allowing the device 300 to adapt to new trends and types of unacceptable content as they emerge.

The reviewer profile and historical reviews data 322 includes information about the reviewers and a history of their submitted reviews. The data 322 may include demographic details, previous review texts, and outcomes of past submissions. The AI-based analysis module 320 may retrieve the information 322 to contextualize current reviews, enhancing the accuracy of sentiment analysis and intent detection.

The moderation rules data 332 includes a comprehensive set of rules derived from legal, ethical, and business-specific guidelines. The data 332 provides a systematic rule-based framework for the moderation rules module 330 to evaluate review content. The data 332 may include conditions and parameters for identifying violations, facilitating a consistent and fair review moderation process.

The parameters 342 include parameters and configurations for machine learning models employed by the AI-based analysis module 320. The parameters 342 provide for and assist in training the supervised and/or unsupervised learning models that enable the device 300 to learn from and adapt to new review data, ensuring the continuous improvement of the moderation system's accuracy and efficiency.

The vector embeddings 352 include vector embeddings of review content, enabling the device 300 to calculate similarity scores between new submissions and historically moderated reviews. The vector embeddings 352 may be utilized by the AI-based analysis module 320 to identify patterns and assess the relevance and authenticity of review submissions based on similarities with previously approved or declined content.

The dynamic feedback loop data 362 may capture feedback from the moderation outcomes to refine the machine learning models and update the moderation rules database. The data 362 may include data on reviews that were manually approved or declined post-AI moderation, providing a feedback mechanism that allows for the iterative tuning of algorithms and rules within the system, ensuring its relevance and effectiveness over time.

Through the automation of the decision-making, the decision-making module 340 may advantageously enhance the efficiency of the review moderation cycle, significantly reducing the time span from submission to publication or rejection. This systematic approach not only accelerates the moderation workflow but also mitigates potential human biases, thereby ensuring the publication of reviews that accurately reflect compliant and suitable feedback.

The device 300 incorporates AI algorithms designed to facilitate continuous learning and improvement, leveraging both supervised and unsupervised learning techniques. These algorithms operate within the AI-based analysis module 320, where they continually analyze and learn from patterns and outcomes in a dataset comprising previously moderated reviews. Supervised learning involves the algorithms being trained on a labeled dataset, where each review is marked as either approved or declined, teaching the AI to recognize patterns associated with each outcome. Unsupervised learning, on the other hand, allows the AI to explore the data without predefined labels, enabling it to uncover hidden structures and relationships within the review content.

The technical functionality underpinning this continuous learning mechanism includes the collection and preprocessing of review data, where text is cleaned, normalized, and transformed into a format suitable for machine learning models. The AI-based analysis module 320 applies NLP techniques to extract features from the reviews, such as sentiment, thematic elements, and linguistic patterns. These features form the basis for both training the models in supervised learning scenarios and for the exploratory analysis in unsupervised learning contexts.

Once the feature extraction is complete, the AI-based analysis module 320 employs machine learning algorithms to analyze these features in the context of the review moderation criteria set forth by the moderation rules module 330. In supervised learning, the algorithms adjust their parameters to minimize the difference between the predicted and actual outcomes, refining their ability to classify reviews accurately. In unsupervised learning, clustering and anomaly detection techniques help identify novel or unexpected patterns in review content, which can inform adjustments to the moderation rules or highlight emerging trends in user feedback.

The iterative learning is supported by a feedback loop, where the outcomes of the moderation (i.e., reviews being approved or declined) are fed back into the device 300 to further refine the learning models. This feedback mechanism ensures that the algorithms of the AI-based analysis module continue to evolve in response to new data, enhancing the capacity of the device 300 to adapt to changes in language use, review content trends, and moderation standards over time.

Through this comprehensive and ongoing learning, the device 300 provides that its moderation capabilities remain current and effective against an ever-evolving backdrop of user-generated content. The use of both supervised and unsupervised learning techniques allows the system to not only maintain its accuracy and adaptability in moderating customer reviews but also to anticipate and respond to new challenges, ensuring the long-term reliability and scalability of the moderation system.

The device 300 further includes a display module 350. The display module 350 is configured to provide features such as a screen share and review management interface, allowing administrators to oversee the moderation. Once published, reviews may be held in a pending state for a predetermined period, during which an administrator may have the opportunity to approve or decline the submission manually. The interface may also provide for the moderation of images submitted as part of reviews, ensuring that all forms of customer feedback are subjected to thorough scrutiny. The decision to decline a submission may be communicated to the customer for transparency and feedback in the moderation.

In an embodiment, the AI-based analysis module 320 employs a “similarity approach” by leveraging its own logic and insights retrieved from other reviews and merchant-specific patterns. Data pertaining to the similarity approach may be stored in dynamic feedback loop data 362. The similarity approach includes creating vector embeddings for all content (stored at vector embeddings 352). The vector embeddings 352 include AI-generated data vectors that describe the content to the AI, facilitating the assessment of similarity with other content. The AI-based analysis module 320 may generate the vector embeddings 352 not only for existing content but also for each new review submission. Such generation enables the module 320 to compare the new vector embeddings with existing vector embeddings to determine similarities. In an embodiment, the LLM may be utilized to generate the vector embeddings 352. In an embodiment, the AI-based analysis module 320 supports non-LLM embodiments for comparison, using algorithms to ascertain the similarities between vectors. This capability allows for the identification of content similarity in an “intelligence space.” As a result, even if a review is in a completely different language but conveys the same message, the device 300 may detect this similarity through the vector embeddings 352.

Correspondingly, the memory 304 is configured to store the vector embeddings 352 for all reviewed content, including the proprietary logic that underpins the similarity approach. The vector embeddings 352 may include the embeddings themselves and the algorithms used for generating and comparing the vector embeddings. By maintaining a comprehensive dataset of vector embeddings 352, the memory 304 assists the AI-based analysis module 320 in performing nuanced similarity analyses. This provides for understanding the unique context and nuances of each review, beyond mere textual differences, and making informed moderation decisions based on the overall intelligence and intent conveyed by the review content.

In an embodiment, the AI-based analysis module 320 leverages the vector embeddings 352 as a transformative element using the LLM for content moderation. The vector embeddings 352 offer a nuanced “AI similarity” perspective. This feature enables the device 300 to recognize similarities across different languages and even in the presence of typos, thereby overcoming limitations associated with conventional text analysis techniques.

Vector embeddings may operate as a unique storage unit or an AI-specific language, allowing for the representation of complex concepts and content in a form that AI may readily analyze and interpret. For example, vector embeddings may be used to identify similarities between two visually distinct photos, such as those involving optical illusions, by analyzing them within the “VE language” or space. This capability illustrates the profound impact vector embeddings have on understanding content beyond superficial characteristics, tapping into the deeper semantic connections that AI may perceive.

In an embodiment, the AI-based analysis module 320 may first convert review text into vector embeddings. The process may include translating the natural language content into a high-dimensional vector space. This transformation may be achieved through algorithms that analyze the semantic and syntactic structure of the text, effectively capturing its nuanced meanings in a format that AI can interpret. Each review may be represented as a point in the multidimensional space, where the distance and direction between points reflect the semantic similarities or differences between the reviews. For example, reviews discussing similar themes or sentiments, regardless of their language or surface-level text differences, are positioned closer together. This enables the AI-based analysis module 320 to identify patterns and relationships within the content that are not evident through traditional text analysis.

Upon generating the vector embeddings 352, the AI-based analysis module 320 utilizes the vector embeddings 352 to compare new review submissions against a database of previously analyzed reviews. The previously analyzed reviews may be stored in the reviewer profile and historical review data 322. The comparison may be performed by the LLM. The comparison may be performed by algorithms that calculate the similarity between the vector embedding of the new submission and the embeddings stored in the reviewer profile and historical review data 370. Through this comparison, the AI-based analysis module 320 may identify whether a new review shares significant semantic similarities with any known categories of content, such as those related to specific sentiments, topics, or even nuanced expressions like sarcasm. The feature provides for the efficient sorting and categorization of reviews based on their deeper, contextual similarities, facilitating a more accurate and comprehensive moderation process that extends beyond mere keyword matching to encompass the full semantic depth of the content.

Advantageously, the iterative improvement of the vector embeddings 352 provides for refining the AI-based processing. As more data is processed and more reviews are transformed into vector embeddings, the device 300 is increasingly better able to interpret and classify content in an increasingly refined manner. This self-enhancing mechanism ensures that the utilization of the vector embeddings 352 contributes to the continuous enhancement of the AI-based analysis module 320. Conceptually, vector embeddings may be understood to include a vast tuple measuring trillions of semantic dimensions, offering a rich, multidimensional space for AI to explore and analyze content with unparalleled depth and precision.

In an embodiment, the AI-based analysis module 320 conducts “Standard Checks” on review submissions to identify the presence of external links not related to the site. This process may include scanning the text for hyperlinks and assessing their relevance to the site's content or the context of the review. Additionally, the device 300 references a history of previously moderated reviews (e.g., the reviewer profile and historical review data 322) to determine whether similar links have been approved or rejected in the past, including decisions made by human moderators. The historical analysis may inform the current moderation decision, ensuring consistency and maintaining the integrity of the review content by filtering out irrelevant or potentially malicious external links.

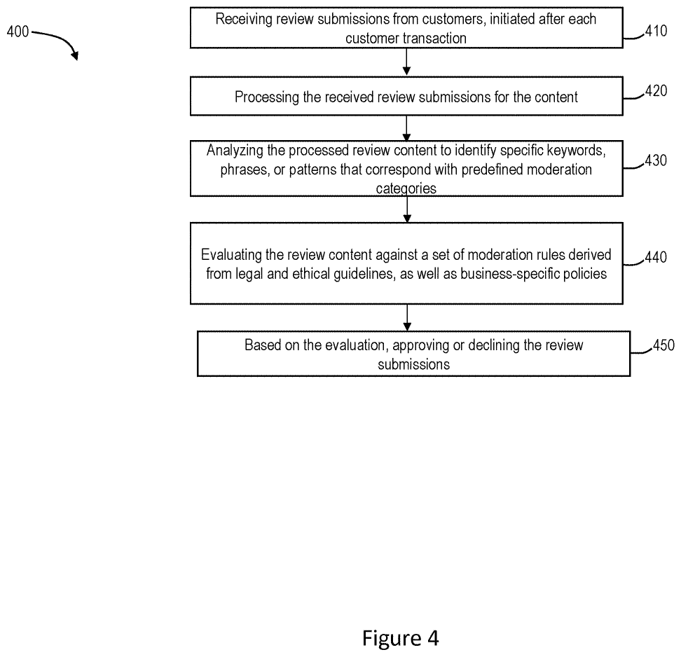

Referring to FIG. 4, shown therein is a flow chart of a method 400 for automated moderation of customer review submissions, according to an embodiment. The method 400 of FIG. 4 may be implemented on the system 100 of FIG. 1. The method 400 of FIG. 4 may be implemented on the device 300 of FIG. 3.

At 410, the method 400 includes receiving review submissions from customers, the review submissions initiated after each customer transaction, such as completing a purchase or settling an invoice. This functionality may be facilitated through an automated system that interfaces directly with business platforms (e.g., the review submissions module 120 of FIG. 1 integrating with the merchant platforms 130), triggering review prompts that encourage customers to share their feedback. These prompts are generated in real-time, utilizing web technologies to ensure a seamless integration with the customer's transactional experience, thereby capturing immediate and relevant feedback for the business.

At 420, the method 400 further includes processing the received review submissions for their content. The parsing may include the application of NLP techniques to deconstruct and analyze the content (e.g., the text). The parsing extracts semantic and contextual meanings from the submissions, breaking down the language to understand the nuances, intent, and sentiment conveyed by the customer. This technical operation provides for preparing the text for deeper analysis, enabling assessment of the review beyond keywords.

At 430, the method 400 further includes analyzing the parsed review content to identify specific keywords, phrases, or patterns that correspond with predefined moderation categories. This analysis leverages sophisticated algorithms to sift through the text, seeking out indicators of spam, hate speech, inappropriate content, and other criteria that would render a review unsuitable for publication. This functionality provides for detecting any content that violates the established moderation framework, employing a detailed examination of language use and thematic content to ensure comprehensive moderation.

At 440, the method 400 further includes evaluating the review content against a set of moderation rules derived from legal and ethical guidelines, as well as business-specific policies. This evaluation includes a systematic comparison of the analyzed content with the moderation rules, assessing each review for its compliance with the guidelines that govern appropriateness, relevance, and overall suitability for publication. The rules are applied in a manner that ensures consistent and fair evaluation of all reviews, using the detailed insights gained from the foregoing analysis to make informed decisions about the alignment of the content with moderation standards.

At 450, the method 400 further includes, based on the evaluation, approving or declining the review submissions. Reviews that align with the moderation policies and meet the established criteria are approved for publication, contributing to the business's online presence and customer engagement efforts. Conversely, reviews identified as violating the moderation guidelines are declined, preventing the display of unsuitable content. This final decision-making functionality is executed automatically, ensuring a swift and unbiased moderation that upholds the integrity of the review system and maintains a high standard of content quality.

The review submissions and content thereof may include any one or more of text, photos, and videos.

In an embodiment, timelines for autonomous and automated moderation of review content are configurable. If the review is positive (in terms of semantic content), such review may be moderated immediately. If the review is negative (in terms of semantic content), such review may be moderated over a longer period, e.g., 14 days. If the review includes photos or videos, such review may be moderated over a longer period than a review that includes only text, e.g., over an extra day. If a merchant has not manually moderated a review, then after a configurable period (e.g., 14 days), the moderation may be performed autonomously and automatically according to the foregoing disclosure.

While the above description provides examples of one or more apparatus, methods, or systems, it will be appreciated that other apparatus, methods, or systems may be within the scope of the claims as interpreted by one of skill in the art.

1. A system for automated customer review moderation, the system comprising:
a review submission module configured to generate or receive review requests from customers after each completed order or invoice payment;
an artificial intelligence (AI) based analysis module configured to process content of review submissions received in response to the review requests and identify keywords, phrases, or patterns related to predefined moderation categories;
a moderation rules engine comprising a set of predefined rules for evaluating the content based on the predefined rules and the predefined moderation categories; and
an approval/decline module configured to determine that a review is to be approved or declined based on the predefined rules and the predefined moderation categories.

2. The system of claim 1, wherein the AI-based analysis module processes the content of the review submissions by representing the content of the review submissions as one or more vector embeddings.

3. The system of claim 2, wherein the AI-based analysis module includes a large language model for generating the one or more vector embeddings.

4. The system of claim 1, wherein the approval/decline module determines that the review is to be approved or declined based on the predefined rules and the predefined moderation categories by comparing one or more vector embeddings to the predefined rules and the predefined moderation categories.

5. The system of claim 4, wherein the approval/decline module includes a large language module for comparing the one or more vector embeddings to the predefined rules and the predefined moderation categories.

6. The system of claim 1, wherein the AI-based analysis module utilizes Natural Language Processing (NLP) techniques to understand the semantic and contextual meaning of the content of the review submissions.

7. The system of claim 1, wherein the set of predefined rules comprises a plurality of rules derived from legal and ethical guidelines.

8. The system of claim 1, wherein the approval/decline module automatically publishes customer reviews that meet criteria for approval according to the predefined rules and/or the predefined moderation categories.

9. The system of claim 1, wherein the approval/decline module automatically declines reviews that violate the predefined rules.

10. The system of claim 1, wherein the AI-based analysis module continuously learns and improves over time through supervised and unsupervised learning techniques, thereby enhancing accuracy and adaptability.

11. The system of claim 1, wherein the content of the review submissions includes textual content, image content, and/or video content.

12. A method for automated customer review moderation, the method comprising:
receiving review submissions from customers after each completed order or invoice payment;
processing the content of the review submissions using AI algorithms;
analyzing the content to identify keywords, phrases, or patterns related to predefined moderation categories;
evaluating the content based on a set of predefined rules and predefined moderation categories; and
approving or declining the review based on the predefined rules and the predefined moderation categories.

13. The method of claim 12, wherein processing the content of the review submissions includes representing the content of the review submissions as one or more vector embeddings.

14. The method of claim 13, wherein the method is implemented, at least in part, on or with a large language model for generating the one or more vector embeddings.

15. The method of claim 12, wherein approving or declining the review includes comparing one or more vector embeddings to the predefined rules and the predefined moderation categories.

16. The method of claim 15, wherein the method is implemented, at least in part, on or with a large language module for comparing the one or more vector embeddings to the predefined rules and the predefined moderation categories.

17. The method of claim 12, wherein the method uses Natural Language Processing (NLP) techniques to understand the semantic and contextual meaning of the content of the review submissions.

18. The method of claim 12, wherein the set of predefined rules comprises a plurality of rules derived from legal and ethical guidelines.

19. The method of claim 12, wherein the method further comprises automatically publishing customer reviews that meet criteria for approval according to the predefined rules and/or the predefined moderation categories.

20. The method of claim 12, wherein the method further comprises automatically declining reviews that violate the predefined rules.

21. The method of claim 12, wherein the method further comprises continuously learning and improving over time through supervised and unsupervised learning techniques, thereby enhancing accuracy and adaptability.

22. The method of claim 12, wherein the content of the review submissions includes textual content, image content, and/or video content.

23. A device for automated customer review moderation, the device comprising:
a review submission module configured to generate or receive review requests from customers after each completed order or invoice payment;
an AI-based analysis module configured to process content of review submissions received in response to the review requests and identify keywords, phrases, or patterns related to predefined moderation categories;
a moderation rules engine comprising a set of predefined rules for evaluating the content based on the predefined rules and the predefined moderation categories; and
an approval/decline module configured to determine that a review is to be approved or declined based on the predefined rules and the predefined moderation categories.

24. The device of claim 23, wherein the AI-based analysis module processes the content of the review submissions by representing the content of the review submissions as one or more vector embeddings.

25. The device of claim 24, wherein the AI-based analysis module includes a large language model for generating the one or more vector embeddings.

26. The device of claim 23, wherein the approval/decline module determines that the review is to be approved or declined based on the predefined rules and the predefined moderation categories by comparing one or more vector embeddings to the predefined rules and the predefined moderation categories.

27. The device of claim 26, wherein the approval/decline module includes a large language module for comparing the one or more vector embeddings to the predefined rules and the predefined moderation categories.

28. The device of claim 23, wherein the AI-based analysis module utilizes Natural Language Processing (NLP) techniques to understand the semantic and contextual meaning of the content of the review submissions.

29. The device of claim 23, wherein the set of predefined rules comprises a plurality of rules derived from legal and ethical guidelines.

30. The device of claim 23, wherein the approval/decline module automatically publishes customer reviews that meet criteria for approval according to the predefined rules and/or the predefined moderation categories.

31. The device of claim 23, wherein the approval/decline module automatically declines reviews that violate the predefined rules.

32. The device of claim 23, wherein the AI-based analysis module continuously learns and improves over time through supervised and unsupervised learning techniques, thereby enhancing accuracy and adaptability.

33. The device of claim 23, wherein the content of the review submissions includes textual content, image content, and/or video content.
